(19) United States
(12) Patent Application Publication
(10) Pub. No.: US 2025/0361118 A1
(43) Pub. Date: Nov. 27, 2025

(54) TENSION ADJUSTMENT METHOD FOR AN ELEVATOR

(71) Applicants: MITSUBISHI ELECTRIC BUILDING SOLUTIONS CORPORATION, Tokyo (JP); Mitsubishi Electric Corporation, Tokyo (JP)

(72) Inventors: Seiji WATANABE, Tokyo (JP); Daisuke NAKAZAWA, Tokyo (JP); Ayaka MIZUTANI, Tokyo (JP); Kakeru YOKOYAMA, Tokyo (JP); Junya YASUTOMI, Tokyo (JP); Sunao FUJIWARA, Tokyo (JP); Yoshiko ONO, Tokyo (JP)

(73) Assignees: MITSUBISHI ELECTRIC BUILDING SOLUTIONS CORPORATION, Tokyo (JP); Mitsubishi Electric Corporation, Tokyo (JP)

(21) Appl. No.: 19/204,679

(22) Filed: May 12, 2025

(30) Foreign Application Priority Data
May 24, 2024 (JP) 2024-084786

(51) Int. Cl. B66B 7/10; B66B 5/12

(52) U.S. Cl. CPC B66B 7/10; B66B 5/12

(57) ABSTRACT

A tension adjustment method for an elevator includes an adjustment-amount determination step of determining a first adjustment amount to be applied to a first rope cleat device. When a part of a suspension body from a first end portion to a driving sheave under a state in which a car and a counterweight are positioned at the same height is defined as a first part, the first adjustment amount is determined from a value proportional to a value obtained by dividing a tension adjustment value being a difference between a pre-adjustment tension value of the suspension body and a target tension value by an equivalent spring constant that is determined when the first part and a rope cleat spring of a first rope cleat device are regarded as a series spring.

### CROSS-REFERENCE TO RELATED APPLICATION

The present application claims the benefit of priority to Japanese Patent Application No. 2024-084786, filed May 24, 2024, which is incorporated herein by reference in its entirety.

### BACKGROUND OF THE INVENTION

### 1. Field of the Invention

This disclosure relates to a tension adjustment method for an elevator.

### 2. Description of the Related Art

In a related-art tension adjustment method for an elevator, a state quantity related to tension of each main rope is detected by a detector. The state quantity detected by the detector is sent to a measurement processing device. The measurement processing device calculates a tension value of each of the main ropes based on the state quantity of the corresponding main rope. The tension value of each of the main ropes is transmitted to a mobile terminal device carried by a maintenance worker. The mobile terminal device creates a plan for tension adjustment work on a plurality of main ropes based on the tension values of the main ropes. The maintenance worker carries out the adjustment work in accordance with the plan for the adjustment work displayed on the mobile terminal device (see, for example, Japanese Patent No. 5268978).

In the related-art tension adjustment method for an elevator as described above, the maintenance worker operates a car in a round trip motion after carrying out the adjustment work. Then, the maintenance worker checks whether or not the tension of each of the main ropes falls within an allowable range. When the tension of any of the main ropes does not fall within the allowable range, re-adjustment work for tension is carried out. Such re-adjustment work is repeatedly carried out until the tension of all the main ropes falls within the allowable range. Thus, the adjustment work for tension requires considerable time and effort.

### SUMMARY OF THE INVENTION

This disclosure has been made in order to solve the problem as described above, and has an object to provide a tension adjustment method for an elevator, which enables reduction in time and effort for entire adjustment work.

According to at least one embodiment of this disclosure, there is provided a tension adjustment method for an elevator, including: an adjustment-amount determination step of determining a first adjustment amount to be applied to a first rope cleat device connected to a first end portion of a suspension body suspending a car and a counterweight; and a rope cleat adjustment step of adjusting the first rope cleat device based on the first adjustment amount. When a part of the suspension body from the first end portion to a driving sheave under a state in which the car and the counterweight are positioned at the same height is defined as a first part, the first adjustment amount is determined, in the adjustment-amount determination step, from a value proportional to a value obtained by dividing a tension adjustment value being a difference between a pre-adjustment tension value of the suspension body and a target tension value by an equivalent spring constant that is determined when the first part and a rope cleat spring of the first rope cleat device are regarded as a series spring.

According to the tension adjustment method for an elevator in at least one embodiment of this disclosure, it is possible to enable reduction in time and effort for entire adjustment work.

### BRIEF DESCRIPTION OF THE DRAWINGS

FIG. 1 is a schematic configuration view for illustrating an elevator according to a first embodiment.

FIG. 2 is a configuration view for illustrating a first rope cleat device of FIG. 1.

FIG. 3 is an explanatory view for schematically illustrating relevant parts of the elevator of FIG. 1.

FIG. 4 is a graph for showing a first example of tension changes of two suspension bodies along with movement of a car.

FIG. 5 is an explanatory view for illustrating a first adjustment amount to be applied to the first rope cleat device and a second adjustment amount to be applied to a second rope cleat device.

FIG. 6 is a graph for showing one example of tension changes of the two suspension bodies of FIG. 4 after tension adjustment.

FIG. 7 is a flowchart for illustrating flow of tension adjustment work of the first embodiment.

FIG. 8 is an explanatory view for schematically illustrating relevant parts of an elevator according to a second embodiment.

FIG. 9 is an explanatory view for schematically illustrating relevant parts of an elevator of a modification example of the second embodiment.

FIG. 10 is a graph for showing a second example of tension changes of two suspension bodies along with movement of a car.

FIG. 11 is a flowchart for illustrating flow of tension adjustment work of a third embodiment.

FIG. 12 is a graph for showing one example of a relationship between discrete tension data and continuous tension data in a fourth embodiment.

FIG. 13 is an explanatory diagram for illustrating a relationship between a tension analysis model and input/output data in the fourth embodiment.

FIG. 14 is a graph for showing one example of a relationship among an upward-movement tension value, a downward-movement tension value, and an average tension value in a fifth embodiment.

FIG. 15 is a flowchart for illustrating flow of tension adjustment work of the fifth embodiment.

FIG. 16 is a graph for showing a third example of tension changes of two suspension bodies along with movement of a car.

FIG. 17 is a graph for showing one example of tension changes of the two suspension bodies of FIG. 16 after tension adjustment.

FIG. 18 is a flowchart for illustrating flow of tension adjustment work of a sixth embodiment.

### DESCRIPTION OF THE EMBODIMENTS

Now, embodiments are described with reference to the drawings.

### First Embodiment

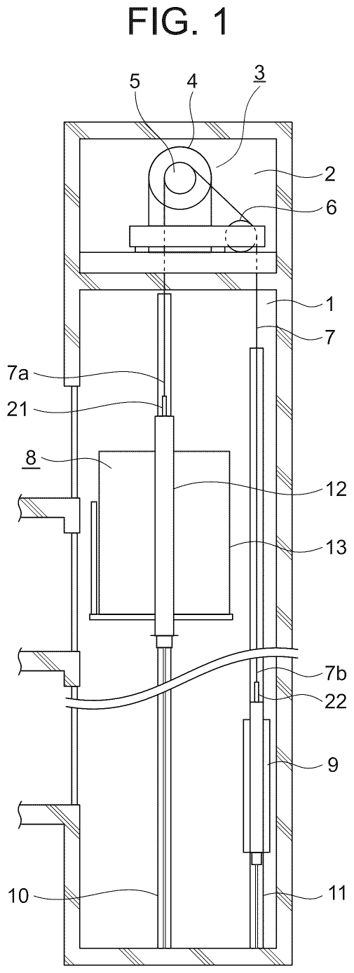

FIG. 1 is a schematic configuration view for illustrating an elevator according to a first embodiment. In FIG. 1, a machine room 2 is provided in an upper part of a hoistway 1. A hoisting machine 3 and a deflector sheave 6 are installed in the machine room 2.

The hoisting machine 3 includes a hoisting machine main body 4 and a driving sheave 5 being a pulley. The hoisting machine main body 4 includes a hoisting machine motor (not shown) and a hoisting machine brake (not shown). The hoisting machine motor rotates the driving sheave 5. The hoisting machine brake holds the driving sheave 5 in a stationary state. Further, the hoisting machine brake brakes rotation of the driving sheave 5.

A plurality of suspension bodies 7 are wound around the driving sheave 5 and the deflector sheave 6. In FIG. 1, only one suspension body 7 is illustrated. As the suspension bodies 7, ropes or belts are used. The driving sheave 5 has a plurality of sheave grooves (not shown). Each of the suspension bodies 7 is inserted into a corresponding one of the sheave grooves.

A car 8 and a counterweight 9 are suspended by the plurality of suspension bodies 7 in the hoistway 1. Further, the car 8 and the counterweight 9 are vertically moved in the hoistway 1 through rotation of the driving sheave 5.

A pair of car guide rails 10 and a pair of counterweight guide rails 11 are installed in a hoistway 1. In FIG. 1, only one of the car guide rails 10 and one of the counterweight guide rails 11 are illustrated.

The pair of car guide rails 10 are configured to guide vertical movement of the car 8. The pair of counterweight guide rails 11 are configured to guide vertical movement of the counterweight 9.

The car 8 includes a car frame 12 and a cage 13. The suspension bodies 7 are connected to the car frame 12. The cage 13 is supported by the car frame 12.

Each of the suspension bodies 7 includes a first end portion 7a and a second end portion 7b. The first end portion 7a is one end portion of the suspension body 7 in its longitudinal direction. The second end portion 7b is an end portion of the suspension body 7 on a side opposite to the first end portion 7a in the longitudinal direction.

A first rope cleat device 21 is connected to each of the first end portions 7a. Each of the first end portions 7a is connected to the car 8 through intermediation of the first rope cleat device 21. A second rope cleat device 22 is connected to each of the second end portions 7b. Each of the second end portions 7b is connected to the counterweight 9 through intermediation of the second rope cleat device 22.

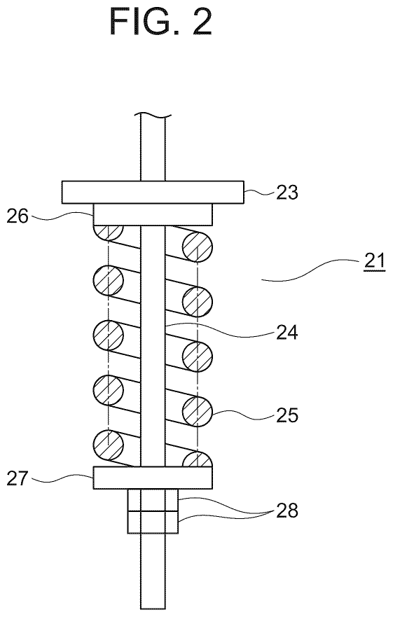

FIG. 2 is a configuration view for illustrating the first rope cleat device 21 of FIG. 1. The first rope cleat device 21 includes a base 23, a shackle rod 24, a rope cleat spring 25, a spring seat 26, a spring holder 27, and a pair of nuts 28.

The base 23 is fixed to a lower surface of an upper beam of the car frame 12. The shackle rod 24 passes through the base 23 and the upper beam. The first end portion 7a of a corresponding one of the suspension bodies 7 is connected to an upper end portion of the shackle rod 24.

The rope cleat spring 25 is arranged below the base 23. Further, the rope cleat spring 25 tenses and compresses depending on tension of a corresponding one of the suspension bodies 7. Further, the shackle rod 24 passes through the rope cleat spring 25.

The spring seat 26 is provided between the rope cleat spring 25 and the base 23. Further, the shackle rod 24 passes through the spring seat 26.

The spring holder 27 is arranged below the rope cleat spring 25. Further, the corresponding shackle rod 24 passes through the spring holder 27. The rope cleat spring 25 is interposed between the spring seat 26 and the spring holder 27.

The pair of nuts 28 are screwed over a lower end portion of the shackle rod 24, that is, a projecting portion of the shackle rod 24 beyond the spring holder 27. The pair of nuts 28 function as a double nut. The tension of a corresponding one of the suspension bodies 7 can be adjusted by adjusting a tightening amount of the pair of nuts 28.

A configuration of the second rope cleat device 22 is the same as the configuration of the first rope cleat device 21.

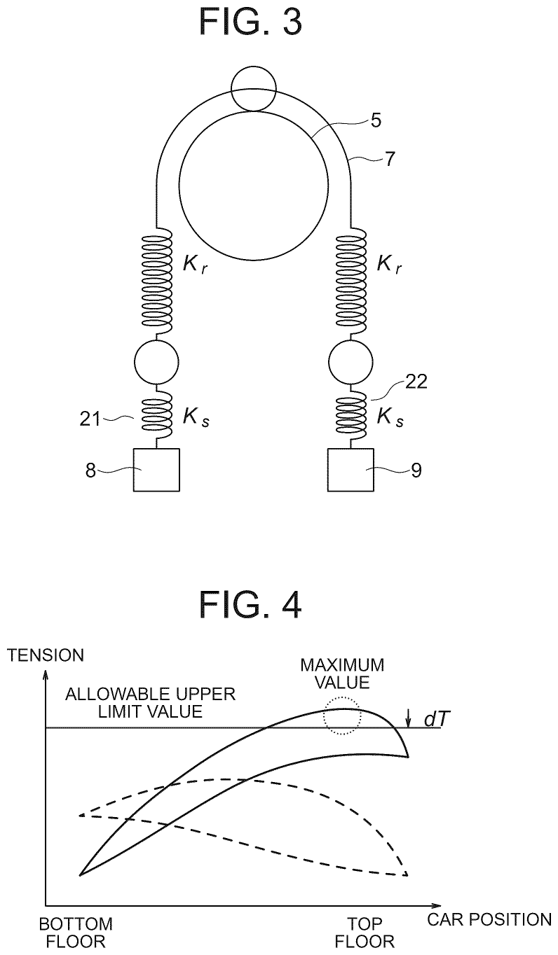

FIG. 3 is an explanatory view for schematically illustrating relevant parts of the elevator of FIG. 1. FIG. 3 shows a state in which the car 8 and the counterweight 9 are positioned at the same height. At this time, a part of the suspension body 7 from the first end portion 7a to the driving sheave 5 is defined as “first part”. Further, a part of the suspension body 7 from the second end portion 7b to the driving sheave 5 is defined as “second part”.

When the car 8 and the counterweight 9 are positioned at the same height, a length of the first part of the suspension body 7 and a length of the second part are equal to each other. Thus, when the first part and the second part are regarded as springs, respectively, a spring constant of the first part and a spring constant of the second part are the same value Kᵣ.

The rope cleat spring 25 of the first rope cleat device 21 is connected in series to the first end portion 7a. A rope cleat spring 25 of the second rope cleat device 22 is connected in series to the second end portion 7b. In this case, it is assumed that a spring constant of the rope cleat spring 25 of the first rope cleat device 21 and a spring constant of the rope cleat spring 25 of the second rope cleat device 22 are the same value Kₛ.

A tension adjustment method according to the first embodiment includes an adjustment-amount determination step, a rope cleat adjustment step, and a round trip step. The adjustment-amount determination step is a step of determining a first adjustment amount to be applied to the first rope cleat device 21 and a second adjustment amount to be applied to the second rope cleat device 22. In this case, the second adjustment amount is determined to be the same value as that of the first adjustment amount.

In the adjustment-amount determination step, the first adjustment amount is determined from a value proportional to a value obtained by dividing a tension adjustment value by an equivalent spring constant. The tension adjustment value is a difference between a pre-adjustment tension value of the suspension body 7 and a target tension value.

The pre-adjustment tension value is a maximum value of the tension of the suspension body 7, which changes along with movement of the car 8. The target tension value is an allowable upper limit value of the tension of the suspension body 7 and is a value obtained by dividing a break strength of the suspension body 7 by a safety factor. The equivalent spring constant is a spring constant that is determined when the first part and the rope cleat spring 25 of the first rope cleat device 21 are regarded as a single series spring.

The spring constant Kᵣ of the first part obtained when the car 8 is positioned at a middle floor may also be referred to as an average value of the spring constant of the suspension body 7, which changes depending on a car position.

The rope cleat adjustment step is a step of adjusting the first rope cleat device 21 based on the first adjustment amount and adjusting the second rope cleat device 22 based on the second adjustment amount.

The round trip step is a step of stabilizing the tension of the suspension body 7 through round trip of the car 8.

FIG. 4 is a graph for showing a first example of tension changes of two suspension bodies 7 along with the movement of the car 8. In FIG. 4, the tension changes of the two suspension bodies 7 when the car 8 is caused to travel in a round trip between a bottom floor and a top floor are shown.

Further, in FIG. 4, the tension change of a first suspension body, which is one of the two suspension bodies 7, is indicated by a solid line, and the tension change of a second suspension body, which is the other one of the two suspension bodies 7, is indicated by a dotted line.

Even when tension of all the suspension bodies 7 has been adjusted uniformly at the time of installation of the elevator, the suspension bodies 7 are stretched over time and the amount of stretch differs among the suspension bodies 7. As a result, the tension also varies among the suspension bodies 7. This can lead to a difference in abrasion amount among the sheeve grooves and also to a difference in tension change between the suspension bodies 7 along with the movement of the car 8, as shown in FIG. 4.

Further, when the car 8 is caused to travel in a round trip, a trajectory of the tension change of each of the suspension bodies 7 is a loop-like one as shown in FIG. 4. That is, a value of the tension of each of the suspension bodies 7 measured when the car 8 is raised is different from that measured when the car 8 is lowered even though the tension is measured at the same car position.

In the example of FIG. 4, in the vicinity of the top floor, a maximum value of the tension of the first suspension body exceeds the allowable upper limit value. Thus, a difference dT between the maximum value and the allowable upper limit value being the target tension value is obtained as the tension adjustment value.

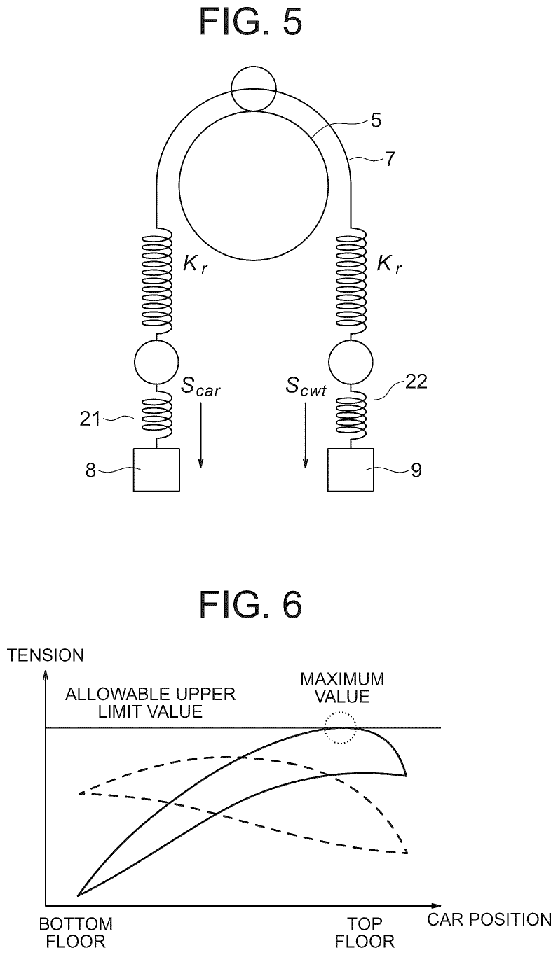

FIG. 5 is an explanatory view for illustrating the first adjustment amount to be applied to the first rope cleat device 21 and the second adjustment amount to be applied to the second rope cleat device 22.

When the tension of the first suspension body changes as indicated by the solid line of FIG. 4, a first adjustment amount S_{car1} for the first suspension body is an adjustment amount to be applied toward a side for loosening the rope cleat spring 25 in order to reduce the tension. Meanwhile, when the tension of the second suspension body changes as indicated by the dotted line of FIG. 4, a first adjustment amount S_{car2} for the second suspension body is an adjustment amount to be applied toward a side for compressing the rope cleat spring 25 in order to increase the tension.

When the adjustment amount applied toward the compressing side is defined as positive, and the adjustment amount applied toward the loosening side is defined as negative, the first adjustment amount S_{car1} for the first suspension body and the first adjustment amount S_{car2} for the second suspension body are given by the following equations, respectively.

S_{car1}=−C×dT/K_{eqv}

S_{car2}=+C×dT/K_{eqv}

In the equations, C represents a constant of proportionality. Further, K_{eqv} represents the equivalent spring constant.

The first adjustment amounts S_{car1} and S_{car2} are proportional to the tension adjustment amount dT, and are inversely proportional to the equivalent spring constant K_{eqv}.

The equivalent spring constant K_{eqv} is obtained by the following equation from the spring constant Kᵣ of the first part of the suspension body 7 and the spring constant Kₛ of the rope cleat spring 25.

K_{eqv}=Kᵣ×_{K}s/(Kᵣ+Kₛ)

Meanwhile, a second adjustment amount S_{cwt1} for the first suspension body and a second adjustment amount S_{cwt2} for the second suspension body are given by the following equations, respectively.

S_{cwt1}=S_{car1}

S_{cwt2}=S_{car2}

That is, the second adjustment amounts S_{cwt1} and S_{cwt2} are the same values as the first adjustment amounts S_{car1} and S_{car2}, respectively.

FIG. 6 is a graph for showing one example of the tension changes of the two suspension bodies 7 of FIG. 4 after tension adjustment. As can be understood from comparison with the graph of FIG. 4, the trajectory of the tension change of the first suspension body after the tension adjustment is generally lower than that before the tension adjustment. Then, after the tension adjustment, a maximum value of the tension of the first suspension body does not exceed the allowable upper limit value.

Further, the trajectory of the tension change of the second suspension body is generally higher than that before the tension adjustment. Thus, a variation in tension between the suspension bodies 7 is suppressed.

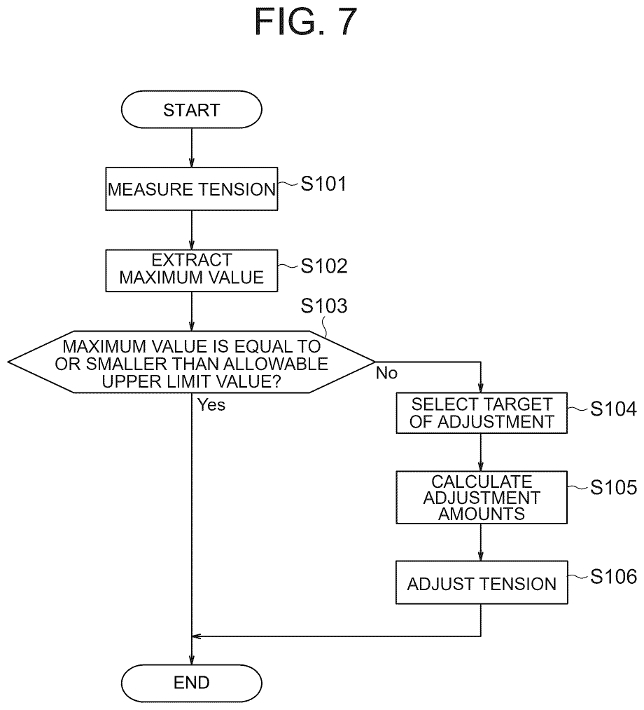

FIG. 7 is a flowchart for illustrating flow of tension adjustment work of the first embodiment. In Step S101 after start of the tension adjustment work, the tension of each of the suspension bodies 7 is continuously measured while the car 8 is being moved. As a result, continuous tension values are acquired.

After that, in Step S102, a maximum value of the tension of each of the suspension bodies 7 is extracted. Then, in Step S103, it is determined whether or not the maximum value of the tension of each of the suspension bodies 7 is equal to or smaller than the allowable upper limit value.

When the maximum values of tension of all the suspension bodies 7 are equal to or smaller than the allowable upper limit value, tension adjustment is not required. Thus, this cycle of work ends.

Meanwhile, when the maximum value of the tension of any of the suspension bodies 7 exceeds the allowable upper limit value, one or more suspension bodies 7 for which the tension is to be adjusted are selected in Step S104. In this case, all the suspension bodies 7 or only part of the suspension bodies 7 may be selected. For example, only the suspension body 7 with the largest maximum value of tension and the suspension body 7 with the smallest maximum value of tension may be selected.

Subsequently, in Step S105, the first adjustment value and the second adjustment value are calculated by the method as described above. Then, in Step S106, the first rope cleat device 21 is adjusted based on the first adjustment amount, and the second rope cleat device 22 is adjusted based on the second adjustment amount. Then, the work ends.

The round trip of the car 8, which is performed after the completion of the tension adjustment work as described above, stabilizes the tension of each of the suspension bodies 7. As a result, the value of the tension of each of the suspension bodies 7 is reduced to be equal to or smaller than the allowable upper limit value as shown in FIG. 6.

According to the tension adjustment method for an elevator as described above, the first adjustment amount is uniquely determined from the value proportional to the value obtained by dividing the tension adjustment value by the equivalent spring constant of the series spring including the first part of the suspension body 7 and the rope cleat spring 25 of the first rope cleat device 21.

Thus, time and effort to repeat the tension adjustment and tension check after the adjustment can be reduced. Hence, reduction in time and effort for the entire adjustment work can be achieved.

Further, also when the tension of a plurality of suspension bodies 7 is to be adjusted, it is only required that a fixed adjustment amount be applied to each of the suspension bodies 7. Thus, it is not required to determine the order of adjustment.

Further, the adjustment amount to be applied to one suspension body 7 is the same regardless of the position of the car 8. Thus, workability can be improved.

Further, in the adjustment-amount determination step, the second adjustment amount is determined to be the same value as that of the first adjustment amount. Thus, the adjustment for the second rope cleat device 22 can also easily be performed.

Further, the pre-adjustment tension value is a maximum value of the tension of the suspension body 7, which changes along with the movement of the car 8. Thus, the maximum value of the tension can be reduced to be equal to or smaller than the allowable upper limit value. Thus, deterioration of the suspension body 7 can be efficiently suppressed.

The target tension value is not limited to the allowable upper limit value, and may be, for example, an allowable lower limit value. In this case, when a minimum value of the tension becomes smaller than the allowable lower limit value, a difference between the minimum value and the allowable lower limit value may be set as the tension adjustment value.

Further, in the rope cleat adjustment step, the adjustment may be performed only for the first rope cleat device 21 without being performed for the second rope cleat device 22. In this case, the first adjustment amount is determined to be a value twice as large as the first adjustment amount that is used when the adjustment is performed for both of the first rope cleat device 21 and the second rope cleat device 22.

For example, when only the first rope cleat device 21 is adjusted, the adjustment amounts are as follows.

S_{car1}=−2×C×dT/K_{eqv}

S_{car2}=+2×C×dT/K_{eqv}

S_{cwt1}=S_{cwt2}=0

In this case, the adjustment is required only for the rope cleat device 21. Thus, work time can be reduced.

Further, the spring constant of the rope cleat spring 25 of the second rope cleat device 22 may be different from the spring constant of the rope cleat spring 25 of the first rope cleat device 21.

In this case, when the spring constant of the rope cleat spring 25 of the first rope cleat device 21 is represented by K_{scar}, and the spring constant of the rope cleat spring 25 of the second rope cleat device 22 is represented by K_{scwt}, an equivalent spring constant K_{eqvcar} on the car 8 side and an equivalent spring constant K_{eqvcwt} on the counterweight 9 side are expressed by the following equations.

K_{eqvcar}=Kᵣ×K_{scar}/(Kᵣ+K_{scar})

K_{eqvcwt}=Kᵣ×K_{scwt}/(Kᵣ+K_{scwt})

The first adjustment amounts S_{car1} and S_{car2} are given by the following equations through use of the equivalent spring constants K_{eqvcar} and K_{eqvcwt}.

S_{car1}=−C×dT/K_{eqvcar}

S_{car2}=+C×dT/K_{eqvcar}

Further, the equivalent spring constant on the counterweight 9 side is different from that on the car 8 side. Thus, the second adjustment amounts S_{cwt1} and S_{cwt2} are given by the following equations.

S_{cwt1}=−C×dT/K_{eqvcwt}

S_{cwt2}=+C×dT/K_{eqvcwt}

Further, when the adjustment is performed only for the first rope cleat device 21, the adjustment amounts are expressed as follows.

S_{car1}=−2×C×dT/K_{eqvcar}

S_{car2}=+2×C×dT/K_{eqvcar}

S_{cwt1}=S_{cwt2}=0

### Second Embodiment

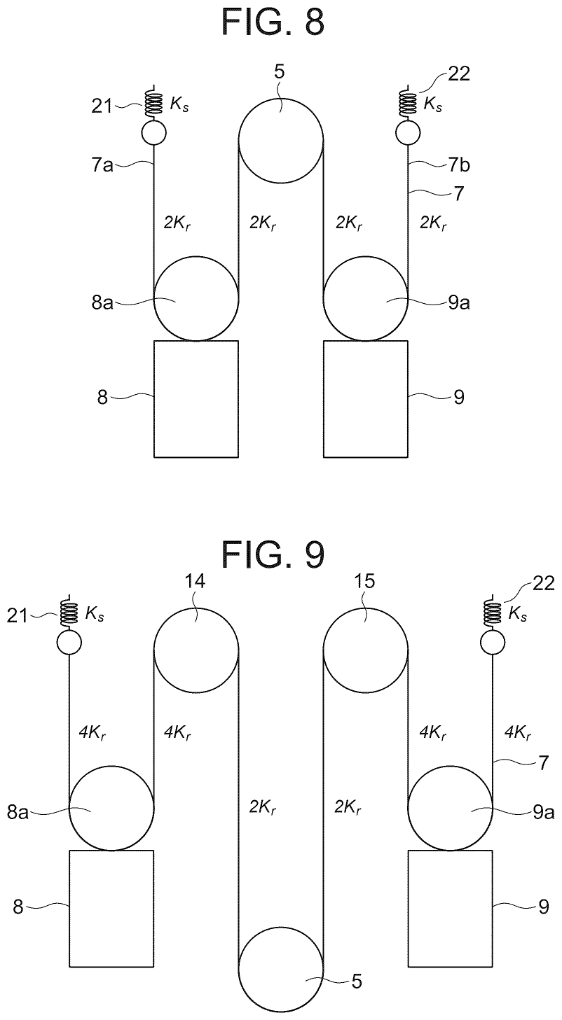

Next, FIG. 8 is an explanatory view for schematically illustrating relevant parts of an elevator according to a second embodiment. A first rope cleat device 21 and a second rope cleat device 22 are provided in an upper part of a hoistway 1. Further, each of the first rope cleat device 21 and the second rope cleat device 22 is installed vertically inversed with respect to that illustrated in FIG. 2.

A car suspension sheave 8a serving as a pulley is provided to a car 8. A counterweight suspension sheave 9a serving as a pulley is provided to a counterweight 9.

A suspension body 7 is wound around the car suspension sheave 8a, a driving sheave 5, and the counterweight suspension sheave 9a in the stated order from a first end portion 7a side toward a second end portion 7b side. That is, the elevator according to the second embodiment is a 2:1 roping elevator.

FIG. 8 shows a state in which the car 8 and the counterweight 9 are positioned at the same height. At this time, a part of the suspension body 7 from the first end portion 7a to the car suspension sheave 8a is defined as “first part”. Further, a part of the suspension body 7 from the second end portion 7b to the counterweight suspension sheave 9a is defined as “second part”.

Further, a part of the suspension body 7 from the driving sheave 5 to the car suspension sheave 8a is defined as “third part”. Further, a part of the suspension body 7 from the driving sheave 5 to the counterweight suspension sheave 9a is defined as “fourth part”.

A length of the first part, a length of the second part, a length of the third part, and a length of the fourth part are equal to each other. Thus, a spring constant of each of the parts is represented by 2Kᵣ. A spring constant of the suspension body 7 on the car 8 side, which is determined by a total length of the first part and the third part, can be calculated as a spring constant of a series spring including two springs each having the spring constant 2Kᵣ, and thus is represented by Kᵣ.

Similarly, a spring constant of the suspension body 7 on the counterweight 9 side, which is determined by a total length of the second part and the fourth part, is also represented by Kᵣ.

Thus, an equivalent spring constant of the series spring, which is determined by the spring constant Kᵣ of the suspension body 7 and a spring constant Kₛ of a rope cleat spring 25, is obtained by the same equation as that for the equivalent spring constant K_{egv} in the first embodiment.

In the 2:1 roping elevator, the car suspension sheave 8a and the counterweight suspension sheave 9a each function as a movable pulley. Thus, tension of the first part and tension of the third part of the suspension body 7 have the same value. Similarly, tension of the second part and tension of the fourth part of the suspension body 7 have the same value.

Thus, when the first adjustment amount used for a 1:1 roping elevator is applied to the first rope cleat device 21 of the 2:1 roping elevator, a tension change amount resulting from the application of the first adjustment amount is distributed to both sides of the car suspension sheaves 8a. As a result, the tension change amount becomes equal to half of a desired tension change amount on each side.

Thus, in order to obtain a desired tension change amount, it is required that the first adjustment amount be twice as large as the first adjustment amount for the 1:1 roping elevator. That is, the first adjustment amount for the 2:1 roping elevator is set twice as large as the first adjustment amount for the 1:1 roping elevator. Otherwise, a tension adjustment method according to the second embodiment is the same as that according to the first embodiment.

With the tension adjustment method for an elevator as described above, reduction in time and effort for the entire adjustment work can be achieved also for the 2:1 roping elevator.

FIG. 9 is an explanatory view for schematically illustrating relevant parts of an elevator of a modification example of the second embodiment. In the modification example of the second embodiment, a driving sheave 5 is arranged in a lower part of a hoistway 1. A car return pulley 14 and a counterweight return pulley 15 are provided in an upper part of the hoistway 1.

A suspension body 7 is wound around a car suspension sheave 8a, the car return pulley 14, the driving sheave 5, the counterweight return pulley 15, and a counterweight suspension sheave 9a in the stated order from a first end portion 7a side toward a second end portion 7b side. That is, the elevator of the modification example of the second embodiment is also a 2:1 roping elevator.

FIG. 9 shows a state in which a car 8 and a counterweight 9 are positioned at the same height. At this time, a part of the suspension body 7 from the first end portion 7a to the car suspension sheave 8a is defined as “first part”. Further, a part of the suspension body 7 from the second end portion 7b to the counterweight suspension sheave 9a is defined as “second part”.

Further, a part of the suspension body 7 from the car suspension sheave 8a to the car return pulley 14 is defined as “third part”. Further, a part of the suspension body 7 from the car return pulley 14 to the driving sheave 5 is defined as “fourth part”. Further, a part of the suspension body 7 from the counterweight suspension sheave 9a to the counterweight return pulley 15 is defined as “fifth part”. Further, a part of the suspension body 7 from the counterweight return pulley 15 to the driving sheave 5 is defined as “sixth part”.

In this case, a spring constant of the first part is represented by 4Kᵣ, a spring constant of the third part is represented by 4Kᵣ, and a spring constant of the fourth part is represented by 2Kᵣ. Further, a spring constant of the second part is represented by 4Kᵣ, a spring constant of the fifth part is represented by 4Kᵣ, and a spring constant of the sixth part is represented by 2Kᵣ.

Further, in the configuration of FIG. 9, as in the configuration of FIG. 8, the car suspension sheave 8a and the counterweight suspension sheave 9a each function as a movable pulley. Thus, a first adjustment amount is set twice as large as the first adjustment amount for the 1:1 roping elevator.

Thus, also in the 2:1 roping elevator as illustrated in FIG. 9, reduction in time and effort for the entire adjustment work can be achieved.

In the configurations of FIG. 8 and FIG. 9, the adjustment may be performed for both of the first rope cleat device 21 and the second rope cleat device 22 or only for the first rope cleat device 21. When the adjustment is not performed for the second rope cleat device 22 and is performed only for the first rope cleat device 21, the first adjustment amount is set twice as large as the first adjustment amount that is set for the adjustment of both of the first rope cleat device 21 and the second rope cleat device 22.

### Third Embodiment

Next, a tension adjustment method for an elevator according to a third embodiment is described. A pre-adjustment tension value in the third embodiment is a larger one of a tension value of a suspension body 7 measured when a car 8 is positioned at a bottom floor and a tension value of the suspension body 7 measured when the car 8 is positioned at a top floor. Otherwise, the tension adjustment method according to the third embodiment is the same as that according to the first embodiment.

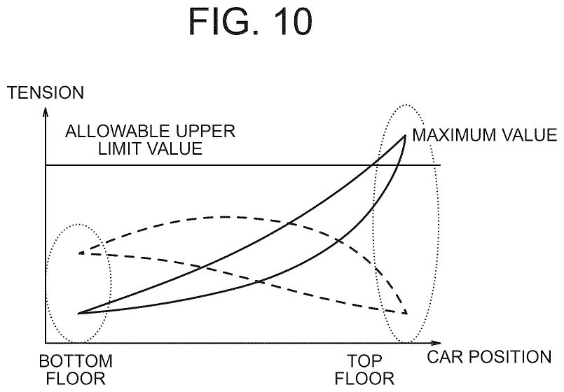

FIG. 10 is a graph for showing a second example of tension changes of two suspension bodies 7 along with movement of the car 8. In FIG. 10, as in FIG. 4, a tension change of a first suspension body is indicated by a solid line, and a tension change of a second suspension body is indicated by a dotted line.

Generally, the tension often reaches its maximum value when the car 8 is stopped at a top floor or a bottom floor.

Thus, in the third embodiment, instead of measuring continuous tension values over the entire travel, a tension value of the suspension body 7 at the time when the car 8 is positioned at the bottom floor and a tension value of the suspension body 7 at the time when the car 8 is positioned at the top floor are measured. Then, a larger one of the tension values is regarded as the maximum value of the tension.

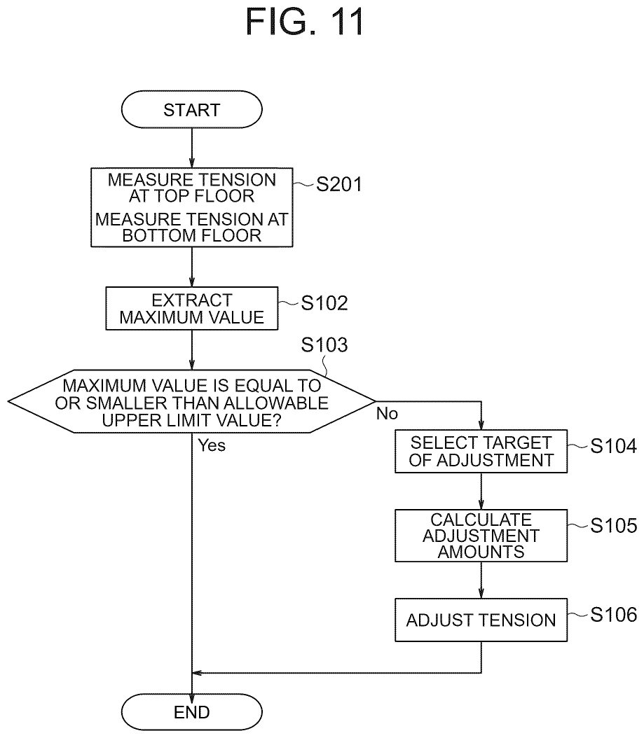

FIG. 11 is a flowchart for illustrating flow of tension adjustment work of the third embodiment. In Step S201 after start of the tension adjustment work, the tension values of the suspension bodies 7 at the time when the car 8 is positioned at the top floor and the tension values of the suspension bodies 7 at the time when the car 8 is positioned at the bottom floor are measured. Any of the tension values at the top floor and the tension values at the bottom floor may be first measured.

Steps after Step S102 are the same as those in the first embodiment.

The tension adjustment method as described above also enables reduction in time and effort for the entire adjustment work. Further, in comparison to a case in which continuous tension values are acquired, the amount of data processing can be significantly reduced, and hence time for tension measurement can be shortened. As a result, time required for the entire adjustment work can be shortened.

Also for the 2:1 roping elevator as described in the second embodiment, the pre-adjustment tension value may be determined in the same manner as in the third embodiment.

### Fourth Embodiment

Next, a tension adjustment method for an elevator according to a fourth embodiment is described. In the fourth embodiment, continuous tension data, which corresponds to a tension change of a suspension body 7 over the entire travel, is obtained by inputting discrete tension data into a tension analysis model. The discrete tension data is a tension value of the suspension body 7, which is measured in only a part of the travel of a car 8.

A maximum value of the tension is extracted from the obtained continuous tension data. Then, the extracted maximum value is used as a pre-adjustment tension value. Otherwise, the tension adjustment method according to the fourth embodiment is the same as that according to the first embodiment.

The tension analysis model receives the discrete tension data and a plurality of parameters as input data and outputs the continuous tension data as output data. Further, in the tension analysis model, a displacement amount applied to a pulley-side end portion of a wound part of each of the suspension bodies 7 is set as a free length of the suspension body 7. The free length of the suspension body 7 is a value obtained by subtracting a stretch amount of the suspension body 7 in a wound amount from the wound amount of the suspension body 7 around the pulley.

The plurality of parameters include a plurality of kinds of data related to specifications of the suspension body 7 and data related to a groove abrasion amount.

The plurality of kinds of data related to the specifications of the suspension body 7 include a Young's modulus E, a sectional area A, a rope diameter “d”, a linear density ρ, the number N of suspension bodies, and a spring constant Kₛ of a rope cleat spring 25. At least one of those pieces of data, for example, the rope diameter “d” may be a fixed value. The data related to the groove abrasion amount is an actually measured value of a depth of each of the sheave grooves.

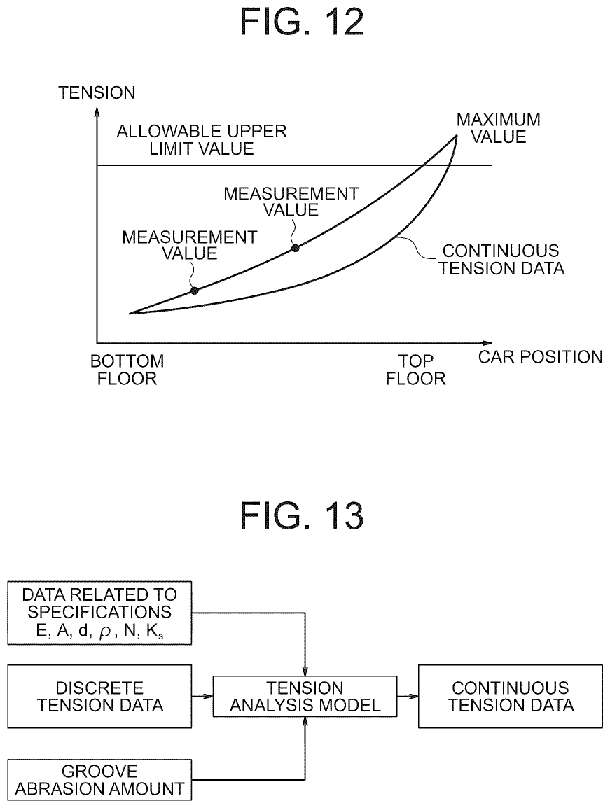

FIG. 12 is a graph for showing one example of a relationship between the discreate tension data and the continuous tension data in the fourth embodiment. FIG. 13 is an explanatory diagram for illustrating a relationship between the tension analysis model and the input/output data in the fourth embodiment.

With the tension adjustment method according to the fourth embodiment, the discrete tension data and the plurality of parameters are input to the tension analysis model as described above. As a result, the continuous tension data is output. As the discrete tension data, for example, one or two or more measurement values as shown in FIG. 12 are input to the tension analysis model.

Also the tension adjustment method as described above enables reduction in time and effort for the entire adjustment work. Further, in comparison to a case in which the continuous tension values are acquired by measurement, tension measurement time can be shortened. As a result, time required for the entire adjustment work can also be shortened.

As in the fourth embodiment, a pre-adjustment tension value may also be determined for the 2:1 roping elevator as described in the second embodiment.

### Fifth Embodiment

Next, a tension adjustment method for an elevator according to a fifth embodiment is described. In the first to fourth embodiments, the allowable upper limit value for the suspension body 7 is set as the target tension value. Meanwhile, in the fifth embodiment, an average value of average tension values of all the suspension bodies 7 is set as a target tension value.

The average tension value is an average value of an upward-movement tension value and a downward-movement tension value of each of the suspension bodies 7. The upward-movement tension value is a tension value of the suspension body 7, which is measured at a middle floor at which the car 8 is positioned after being raised from a bottom floor. The downward-movement tension value is a tension value of the suspension body 7, which is measured at the middle floor at which the car 8 is positioned after being lowered from a top floor. The upward-movement tension value and the downward-movement tension value are measured at the same middle floor.

A pre-adjustment tension value of each of the suspension bodies 7 is the average tension value. A tension adjustment value for each of the suspension bodies 7 is a difference between the pre-adjustment tension value of the corresponding suspension body 7 and a target tension value. A first adjustment amount to be applied to each of first rope cleat devices 21 is calculated in the same manner as in the first or second embodiment.

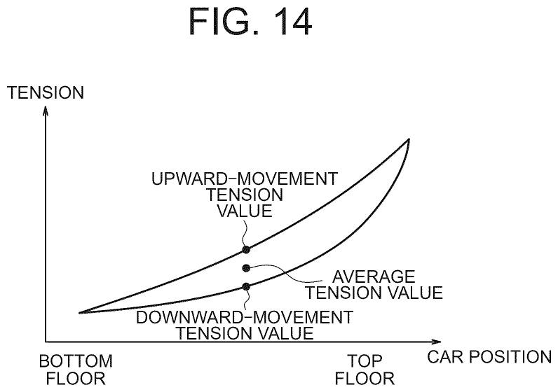

FIG. 14 is a graph for showing one example of a relationship among the upward-movement tension value, the downward-movement tenson value, and the average tension value in the fifth embodiment. When a plurality of sheave grooves have a difference in the abrasion amount, the tension of each of the suspension bodies 7 changes along different trajectories when the car 8 is raised and when the car 8 is lowered.

Meanwhile, when the average tension values of all the suspension bodies 7 at the middle floor can be matched with each other, a variation in tension over the entire travel can be reduced.

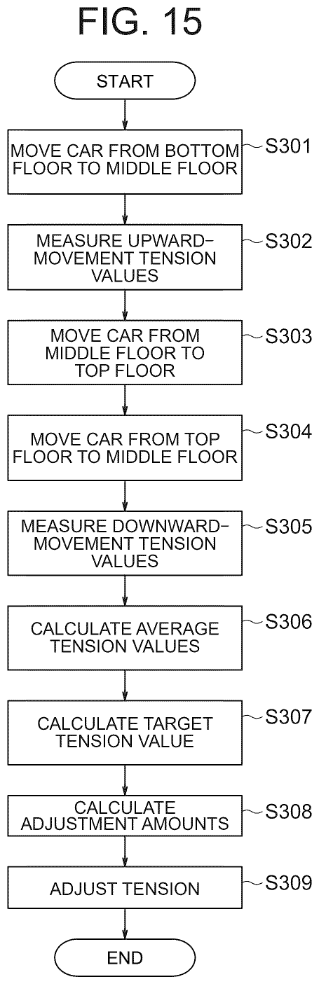

FIG. 15 is a flowchart for illustrating flow of tension adjustment work of the fifth embodiment. In Step S301 after start of the tension adjustment work, the car 8 is moved from the bottom floor to the middle floor. Then, in Step S302, the upward-movement tension value of each of the suspension bodies 7 is measured at the middle floor.

After that, in Step S303, the car 8 is moved from the middle floor to the top floor. Subsequently, in Step S304, the car 8 is moved from the top floor to the middle floor. Then, in Step S305, the downward-movement tension value of each of the suspension bodies 7 is measured at the middle floor.

Next, in Step S306, the average tension value of each of the suspension bodies 7 is calculated. Subsequently, in Step S307, the target tension value is calculated by averaging the average tension values of all the suspension bodies 7.

After that, in Step S308, the first adjustment amount to be applied to each of the first rope cleat devices 21 is calculated. A second adjustment amount to be applied to each second rope cleat device 22 is determined in the same manner as in the first or second embodiment.

Next, in Step S309, adjustment work for the first rope cleat devices 21 and the second rope cleat devices 22 or adjustment work for only the first rope cleat devices 21 is performed. Then, the tension adjustment work ends.

Any of the upward-movement tension value and the downward-movement tension value may be first measured.

Also the tension adjustment method as described above enables reduction in time and effort for the entire adjustment work. Further, the average tension values of all the suspension bodies 7 at the middle floor can be matched with each other, and a variation in tension over the entire travel can be reduced.

As a result, an increase in variation in the abrasion amount among the sheave grooves due to a variation in tension can be suppressed. When an increase in variation in the abrasion amount among the sheave grooves is successfully suppressed, a variation in tension change at each car position can be suppressed, that is, a gradient of the tension change with respect to the car position can be reduced. Thus, deterioration of the suspension bodies 7 due to excessively large tension can be suppressed.

Also in the 2:1 roping elevator as described in the second embodiment, the target tension value and the pre-adjustment tension value may be determined in the same manner as in the fifth embodiment.

### Sixth Embodiment

Next, a tension adjustment method for an elevator according to a sixth embodiment is described. In the sixth embodiment, an average value of specific-floor tension values of all suspension bodies 7 is set as a target tension value. The specific-floor tension value is a tension value of each of the suspension bodies 7, which is obtained when a car 8 is positioned at any appropriate position that is not limited to a bottom floor, a top floor, a middle floor, or the like.

A pre-adjustment tension value of each of the suspension bodies 7 is the specific-floor tension value. A tension adjustment value of each of the suspension bodies 7 is a difference between the pre-adjustment tension value of the corresponding suspension body 7 and a target tension value. A first adjustment amount to be applied to each first rope cleat device 21 is calculated in the same manner as in the first or second embodiment.

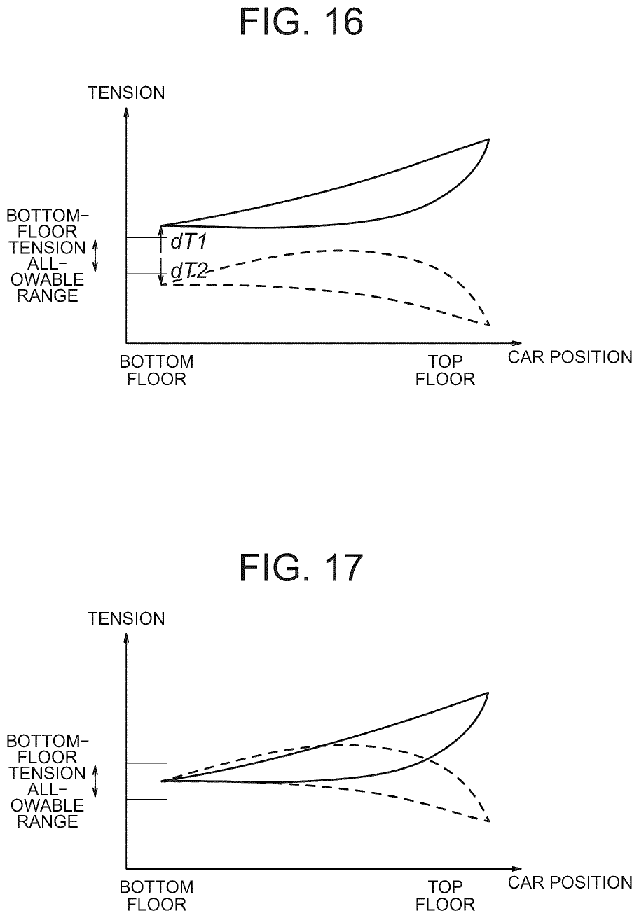

Here, description is made of a case in which the specific floor is the bottom floor. FIG. 16 is a graph for showing a third example of tension changes of two suspension bodies 7 along with movement of a car 8. In FIG. 16, as in FIG. 4, a tension change of a first suspension body is indicated by a solid line, and a tension change of a second suspension body is indicated by a dotted line.

In FIG. 16, the tension values of both of the first suspension body and the second suspension body at the bottom floor lie outside a bottom-floor tension allowable range. The bottom-floor tension allowable range is a preset range that is centered around the target tension value. When the tension at the bottom floor is measured under the above-mentioned state, shift amounts from the target tension value, that is, tension adjustment values dT1 and dT2 can be obtained.

Even when the number of suspension bodies 7 is three or more, it is only required that shift amounts dT1, dT2, dT3, and so on of all the suspension bodies 7 from the average value of the specific-floor tension values be obtained in the same manner.

First adjustment amounts S_{car1} and S_{car2} and second adjustment amounts S_{cwt1} and S_{cwt2} can be obtained by the following equations.

S_{car1}=−C×dT1/K_{eqvcar}

S_{car2}=+C×dT2/K_{eqvcar}

S_{cwt1}=−C×dT1/K_{eqvcwt}

S_{cwt2}=+C×dT2/K_{eqvcwt}

FIG. 17 is a graph for showing one example of tension changes of two suspension bodies 7 of FIG. 16 after the tension adjustment. In FIG. 17, tension values of both of the first suspension body and the second suspension body at the bottom floor fall within the bottom-floor tension allowable range.

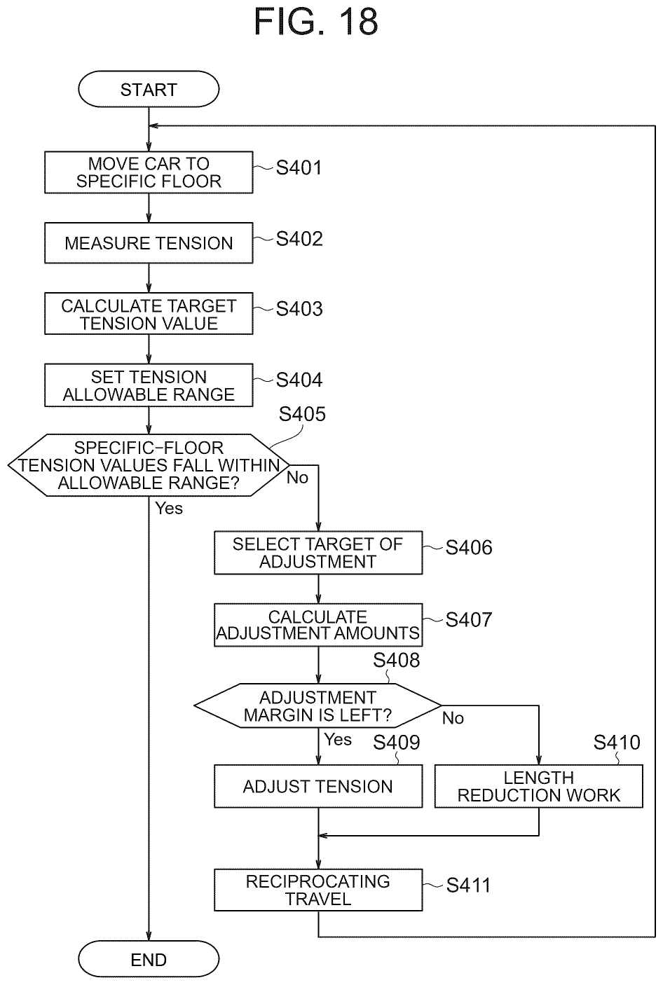

FIG. 18 is a flowchart for illustrating flow of tension adjustment work of the sixth embodiment. In Step S401 after start of the tension adjustment work, the car 8 is moved to a specific floor, in this example, the bottom floor. Then, in Step S402, tension of each of the suspension bodies 7 is measured as the specific-floor tension value.

After that, in Step S403, the target tension value is calculated from the specific floor values of all the suspension bodies 7. Then, in Step S404, a tension allowable range is set based on the target tension value.

Next, in Step S405, it is determined whether or not the specific-floor tension values of the suspension bodies 7 fall within the tension allowable range. When the specific-floor tension values of all the suspension bodies 7 fall within the tension allowable range, this cycle of work ends.

When the specific-floor tension value of any of the suspension bodies 7 does not fall within the tension allowable range, one or more suspension bodies 7 for which the tension is to be adjusted are selected in Step S406. Subsequently, in Step S407, the first adjustment amount to be applied to the first rope cleat device 21 corresponding to the selected suspension body 7 is calculated. The second adjustment amount is determined in the same manner as in the first or second embodiment.

After that, in Step S408, it is checked whether or not rope cleat devices among the first rope cleat devices 21 and the second rope cleat devices 22, which are to be adjusted, have an adjustment margin. That is, it is checked whether or not a pair of nuts 28 can be screwed over a male thread portion of a shackle rod 24 by a required amount.

When a required adjustment margin is left, adjustment work for the first rope cleat devices 21 and the second rope cleat devices 22 or adjustment work for only the first rope cleat devices 21 is performed in Step S409.

When the required adjustment margin is not left, length reduction work for the suspension bodies 7 is performed in Step S410.

After Step S409 and after Step S410, a round trip step of causing the car 8 to travel in a round trip is carried out in Step S411. As a result, the tension of each of the suspension bodies 7 is stabilized.

After the round trip step, the work returns to Step S401. The above-mentioned work is performed until the specific-floor tension values of all the suspension bodies 7 fall within the tension allowable range. However, the first adjustment amount is uniquely determined, and thus the number of repetitions of the work is zero or significantly reduced. Accordingly, reduction in time and effort for the entire adjustment work can be achieved.

In this case, the number of times of round trip of the car 8 in the round trip step is determined based on travel of the car 8 and the number of pulleys around which the suspension bodies 7 are wound.

As a result, an unnecessarily large number of times of round trip are not required to be performed, and hence maintenance work time can be shortened. Further, the checking of tension under a state in which the tension of each of the suspension bodies 7 is unstable after the tension adjustment is suppressed. Thus, the tension after the adjustment can be more precisely checked.

When the tension adjustment is performed only on the car 8 side, a micro-slip of the suspension bodies 7 on the driving sheave 5 is required so that the tension adjustment amount applied on the car 8 side is transmitted to the counterweight 9 side. The micro-slip corresponds to creep occurring due to a difference in tension between the car 8 side and the counterweight 9 side.

The micro-slip is a small value. Thus, a certain travel distance is required so that the tension adjustment amount on the car 8 side is transmitted to the counterweight 9 side to achieve a steadily stable state of tension. Thus, for an elevator with short travel, in particular, the car 8 is required to be caused to travel in a round trip a plurality of times after the tension adjustment.

Meanwhile, for an elevator with long travel, when the car 8 is caused to travel in a round trip only once after the tension adjustment, a stable tension state can be achieved.

In the 2:1 roping elevator including pulleys other than the driving sheave 5, a micro-slip occurs on each of the pulleys. Thus, the first adjustment amount applied to the first rope cleat device 21 is transmitted to the end portion of the suspension body on the counterweight side via micro-slips on a plurality of pulleys. Thus, in comparison to the 1:1 roping elevator, a stable tension state is less likely to be achieved.

Thus, under the same travel condition, as the number of pulleys increases, the number of times of round trip required to achieve a stable tension state increases.

As described above, the number of times of round trip of the car 8 until a stable tension state is achieved after the tension adjustment depends on the travel of the car 8 and the number of pulleys. Thus, the number of times of round trip of the car 8, which is required to achieve a stable tension state, can be determined by performing analysis of applying the tension adjustment amount to each of the suspension bodies 7 in the analysis and causing the car 8 to travel.

Specifically, the analysis may be conducted in advance with different lengths of travel and different numbers of pulleys so as to arrange in advance required numbers of times of round trip of the car 8 into a table determined by combinations of the travel and the number of pulleys.

When the tension adjustment is performed on both of the car 8 side and the counterweight 9 side, a required number of times of round trip of the car 8 is different from that in a case in which the tension adjustment is performed on only one side. Also in this case, however, the required number of times of round trip of the car 8 can be managed similarly based on the analysis in accordance with a table determined by the combinations of the travel and the number of pulleys.

Further, the above-mentioned table can be created based on the results of actual experiments conducted under various conditions in place of the analysis.

The specific floor in the sixth embodiment may be a floor other than the bottom floor and the top floor. When a floor other than the bottom floor and the top floor is set as the specific floor, an average value is obtained from a car upward-movement tension value and a car downward-movement tension value, which are measured at the specific floor, and is set as the specific-floor tension value.

Further, in the first to sixth embodiments, the first end portion 7a and the second end portion 7b of the suspension body 7 may be interchanged. That is, the counterweight 9 may be connected to the first end portion 7a through intermediation of the first rope cleat device 21, and the car 8 may be connected to the second end portion 7b through intermediation of the second rope cleat device 22. In this case, the tension may be adjusted only on the counterweight 9 side.

What is claimed is:

1. A tension adjustment method for an elevator, comprising:
an adjustment-amount determination step of determining a first adjustment amount to be applied to a first rope cleat device connected to a first end portion of a suspension body suspending a car and a counterweight; and
a rope cleat adjustment step of adjusting the first rope cleat device based on the first adjustment amount,
wherein, when a part of the suspension body from the first end portion to a driving sheave under a state in which the car and the counterweight are positioned at the same height is amount defined as a first part, the first adjustment is determined, in the adjustment-amount determination step, from a value proportional to a value obtained by dividing a tension adjustment value being a difference between a pre-adjustment tension value of the suspension body and a target tension value by an equivalent spring constant that is determined when the first part and a rope cleat spring of the first rope cleat device are regarded as a series spring.

2. The tension adjustment method for an elevator according to claim 1,
wherein, in the adjustment-amount determination step, a second adjustment amount to be applied to a second rope cleat device connected to a second end portion of the suspension body is determined to be the same value as the first adjustment amount, and
wherein, in the rope cleat adjustment step, the second rope cleat device is also adjusted based on the second adjustment amount.

3. The tension adjustment method for elevator according to claim 1,
wherein the rope cleat adjustment step is free of adjustment of a second rope cleat device connected to a second end portion of the suspension body, and
wherein, in the adjustment-amount determination step, the first adjustment amount is determined to be a value twice as large as the first adjustment amount determined when both of the first rope cleat device and the second rope cleat device are adjusted in the rope cleat adjustment step.

4. The tension adjustment method for an elevator according to claim 1, wherein the pre-adjustment tension value is a maximum value of tension of the suspension body, which changes along with movement of the car.

5. The tension adjustment method for an elevator according to claim 4, wherein a tension change of the suspension body over entire travel of the car is obtained by inputting a tension value of the suspension body measured only in a part of the travel to a tension analysis model.

6. The tension adjustment method for an elevator according to claim 1, wherein the pre-adjustment tension value is a larger one of a tension value of the suspension body measured when the car is positioned at a bottom floor and a tension value of the suspension body measured when the car is positioned at a top floor.

7. The tension adjustment method for an elevator according to claim 1,
wherein, when an average value of an upward-movement tension value being a tension value of the suspension body measured at a middle floor at which the car is positioned after being raised from a bottom floor and a downward-movement tension value being a tension value of the suspension body measured at the middle floor at which the car is positioned after being lowered from a top floor is defined as an average tension value,
the target tension value is an average value of the average tension values of all the suspension bodies, and
the pre-adjustment tension value is the average tension value of each of the suspension bodies.

8. The tension adjustment method for an elevator according to claim 1,
wherein, when a tension value of the suspension body measured when the car is positioned at any appropriate position is defined as a specific-floor tension value,
the target tension value is an average value of the specific-floor tension values of all the suspension bodies, and
the pre-adjustment tension value is the specific-floor tension value of each of the suspension bodies.

9. The tension adjustment method for an elevator according to claim 1, wherein the first adjustment amount for a 2:1 roping elevator is set twice as large as the first adjustment amount for a 1:1 roping elevator.

10. The tension adjustment method for an elevator according to claim 1, further comprising a round trip step of causing the car to travel in a round trip to stabilize tension of the suspension body after the rope cleat adjustment step,
wherein the number of times of round trip of the car in the round trip step is determined based on travel of the car and the number of pulleys around which the suspension body is wound.
